(19) United States
(12) Patent Application Publication
(10) Pub. No.: US 2016/0371716 A1
(43) Pub. Date: Dec. 22, 2016

(54) LOYALTY REWARDS IN OFFLINE PAYMENT SYSTEM

(71) Applicant: GOOGLE INC., Mountain View, CA (US)

(72) Inventors: Erwin Aitenbichler, Zurich-Horgen (CH); Iyad Assad, Ruschlikon (CH); Aneto Pablo Okonkwo, Zurich (CH)

(21) Appl. No.: 14/744,716

(22) Filed: Jun. 19, 2015

(51) Int. Cl. G06Q 30/02; G06Q 20/38

(52) U.S. Cl. CPC G06Q 30/0233; G06Q 20/387

(57) ABSTRACT

A method for redeeming rewards during an offline payment transaction. Once a user reaches a reward threshold, a reward certificate is transmitted to a merchant device by an account system. The user initiates a payment transaction when the devices are without network access to the account system. The user device transmits a withdrawal record, a transaction history, a reward redemption history, and an identification to the merchant device. The merchant device determines whether the user has an available reward, whether additional funds are required to process the offline payment transaction, and whether the user device has a sufficient balance to complete the offline payment transaction. The merchant device prepares a withdrawal record, writes it to the user device, and saves it until the merchant device has network access. When the merchant device has network access, it transmits the withdrawal record and transaction history to the account system.

### TECHNICAL FIELD

The present disclosure relates to redemption of loyalty rewards performed offline and without network access to a system administering and/or managing the reward program and monitoring a user's reward balance for reward verification and processing, providing improved data gathering, improved reward processing speed, improved reward processing accuracy, and improved ability to monitor and redeem loyalty rewards in an offline payment transaction.

### BACKGROUND

Proximity communication technology has a limited range of one meter or less and can enable merchant device payment technologies. The short communication distances enable customer identification and secure communication between proximity communication enabled devices. Such proximity communication technologies comprise Near Field Communication (NFC), Radio frequency identification (RFID), or Bluetooth Low Energy (BLE). In operation of an NFC transaction, a user “taps” a device, such as an NFC-enabled mobile phone or NFC-enable smart card, to a reader. The reader recognizes the NFC-enabled device when the device is moved within range of the reader, establishes a secure communication channel with the device, and initiates a payment transaction between the reader and the device. In operation of a BLE transaction, a user brings a device, such as a BLE-enabled mobile phone into close proximity of another BLE-enabled device, such as another BLE-enabled mobile phone. The BLE devices detect that they are in proximity of each other and can establish a secure communication channel to initiate a payment transaction.

Smart cards are devices with an embedded integrated circuit (for example, a microprocessor and/or memory) to store data. Smart card devices typically are credit card sized electronic devices that have a variety of uses and can be utilized in any transaction that involves the exchange of data or information. Smart card device technology has been particularly useful in financial transaction systems. Smart card devices generally do not include a data entry device for direct entry of data. Instead, a smart card device is used in conjunction with a card reader and/or an input device. Like smart card devices, mobile communication devices can be utilized in a transaction that involves the exchange of data or information, for example, in financial transactions. Traditionally, a smart card device or mobile communication device is linked to a financial account or contains financial account information. Consequently, when the device is used, the reader receives the financial account information and conducts a debit transaction from the financial account, requiring network access to process the on-line transaction. Such conventional smart card and mobile communication devices are inoperable when access to a network or to specific computers on the network is not available.

Merchants offer coupons, rewards, or rebates as incentives for purchases. Traditionally, coupons are distributed in a paper format. A user redeems the coupon by taking the physical coupon to a merchant and purchasing a product that satisfies the terms of the coupon. Such system is limited in that users are required to clip or print out paper coupons and present such coupons to the merchant to redeem the and reward. Other forms of traditional coupons include rebate and rewards for purchasing particular products, wherein after purchasing a product that satisfies the terms of the rebate offer, the user fills out and returns required forms to request the rebate. Such system is also limited in that the and reward is not automatically applied and the user is required to submit additional paperwork to receive the and reward at a later time. Also, because such rewards are usually requested and/or sent by mail, these and rewards carry a great deal of unreliability and hassle for the user.

More recently, merchants have offered electronic offers and rewards linked to merchant loyalty cards. A user enrolls in a merchant's loyalty program and receives a loyalty card. A user then accumulates a reward balance by presenting the loyalty card (or some form of identifying information, such as a telephone number) and the method of payment to the merchant. However, such systems are limited in that users are required to present a loyalty card (or some form of identifying information, such as a telephone number), in addition to the method of payment, to redeem the reward. Additionally, when the merchant loyalty card and method of payment are presented, the merchant is required to contact the reward administrator to verify and/or process the reward, requiring network access to process the on-line transaction. Such conventional reward redemption is inoperable when access to a network or to specific computers on the network is not available.

### SUMMARY

In certain example aspects described herein, a method for redeeming rewards during offline payment transactions comprises a merchant operating one or more merchant computing devices and enrolled in a reward redemption program maintained by an account management system. Once the user reaches a reward threshold, a reward certificate is transmitted to the merchant computing device during an online communication between the merchant computing device and the account management system. The user indicates a desire to complete an offline payment transaction with a merchant when the devices are without network access to the account management system. The merchant computing device transmits a payment request to the user computing device, and the user computing device transmits a withdrawal record for an amount indicated on the payment request with a complete transaction history, a reward certificate or reward redemption history, and a user identification to the merchant computing device as part of the response to the payment request.

The merchant computing device determines whether the user has an available reward for redemption using the reward certificate received from the account management system and whether the user computing device has redeemed the reward using the transaction history, reward redemption history, or reward certificate received from or read from the user computing device. The merchant computing device determines whether additional funds are required to process the offline payment transaction and determines whether the user computing device has a sufficient balance to complete the offline payment transaction for the addition fund amount. The merchant computing device prepares a withdrawal record, writes it to the user computing device, and saves it until the merchant computing device has network access. When the merchant computing device has network access, it transmits the withdrawal record and transaction history to the account management system.

In certain other example aspects described herein, systems and computer program products to redeem rewards during offline payment transactions are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an offline payment and reward redemption system, in accordance with certain example embodiments.

FIG. 2 is a block flow diagram depicting a method for performing an offline rewards redemption payment transaction, in accordance with certain example embodiments.

FIG. 3 is a block flow diagram depicting a method for receiving reward balance notifications, in accordance with certain example embodiments.

FIG. 4 is a block flow diagram depicting a method for initiating a financial transaction with a merchant, in accordance with certain example embodiments.

FIG. 5 is a block diagram depicting a computing machine and module, in accordance with certain example embodiments.

### DETAILED DESCRIPTION OF THE EXAMPLE EMBODIMENTS

### Overview

The example embodiments described herein provide methods and systems that enable users to redeem rewards during offline payment transactions. In an example embodiment, a merchant operates one or more merchant computing devices and enrolls in a reward redemption program. In this embodiment, the account management system maintains a prepaid account for each user that enables the user to participate in an offline payment transaction with the merchant. The account management system further maintains a reward balance for the user based on the offline payment transactions completed with the merchant. Once the user has reached a reward threshold, a reward certificate is created and transmitted to the merchant computing device during an online/network communication between the merchant computing device and the account management system.

The user indicates a desire to complete an offline payment transaction with a merchant or other transaction counterparty. In an example embodiment, the offline payment transaction occurs when the merchant computing device is without network access to the account management system and is accordingly, unable to receive a verification of available funds or reward balance during the offline payment transaction. The merchant computing device processes and completes the offline payment transaction without network access or verification from an outside system. In an example embodiment, the user “taps” the user computing device within a predefined distance of a merchant computing device, and the devices establish a communication channel. For example, the devices communicate via a near field communication (NFC), Bluetooth, or short-range communication channel. The merchant computing device transmits a payment request to the user computing device, and the user computing device generates a withdrawal record for an amount indicated on the payment request received from the merchant computing device. In an example embodiment, the user computing device transmits a complete transaction history, a reward certificate or reward redemption history, and a user identification to the merchant computing device as part of the response to the payment request.

The merchant computing device verifies the identity of the user and determines whether the user has an available reward for redemption by cross-referencing the reward certificate received from the account management system. In an example embodiment, the merchant computing device determines whether the user computing device has redeemed the reward by reviewing the transaction history, reward redemption history, or reward certificate received from or read from the user computing device. The merchant computing device determines whether additional funds are required to process the offline payment transaction and determines whether the user computing device has a sufficient balance to complete the offline payment transaction for the addition fund amount.

In an example embodiment, the merchant computing device prepares a withdrawal record, writes it to the user computing device, and saves it until the merchant computing device has network access. When the merchant computing device has network access, it transmits the withdrawal record and transaction history to the account management system.

By relying on the methods and systems described herein, the merchant computing device is able to process, authorize, and complete a reward redemption during an offline payment transaction, without network access to the account management system that maintains the user's reward account. As such, the systems and methods described herein may be employed to provide processing and verification of reward availability at a time when the user is most in need of such information—during a payment transaction—even when such payment transaction occurs in an offline environment. The systems and methods described herein may also be employed to provide a more accurate and expedited responsiveness to a reward redemption request, when network access is unavailable, for example, in developing countries and in underground or metro-type environments. Additionally, the systems and methods described herein provide a means by which multiple merchant computing devices can operated independently and in an offline environment to process offline payment transactions and accrue reward benefits across the multiple devices. The reward balance is accrued by a central account management system and made available for redemption at any one of multiple merchant computing devices, while preventing multiple redemptions and over spending. Hence, the systems and methods described herein bridge the gap between the online and offline worlds and allow for the interaction between different types of computing technologies (for example, merchant point-of-sale computing devices, user mobile computing devices, and account management system computing devices) to achieve improved data gathering, improved logging of reward redemption transactions in an offline environment and without confirmation of prior redemption transaction.

Various example embodiments will be explained in more detail in the following description, read in conjunction with the figures illustrating the program flow.

### Example System Architectures

Turning now to the drawings, in which like numerals indicate like (but not necessarily identical) elements throughout the figures, example embodiments are described in detail.

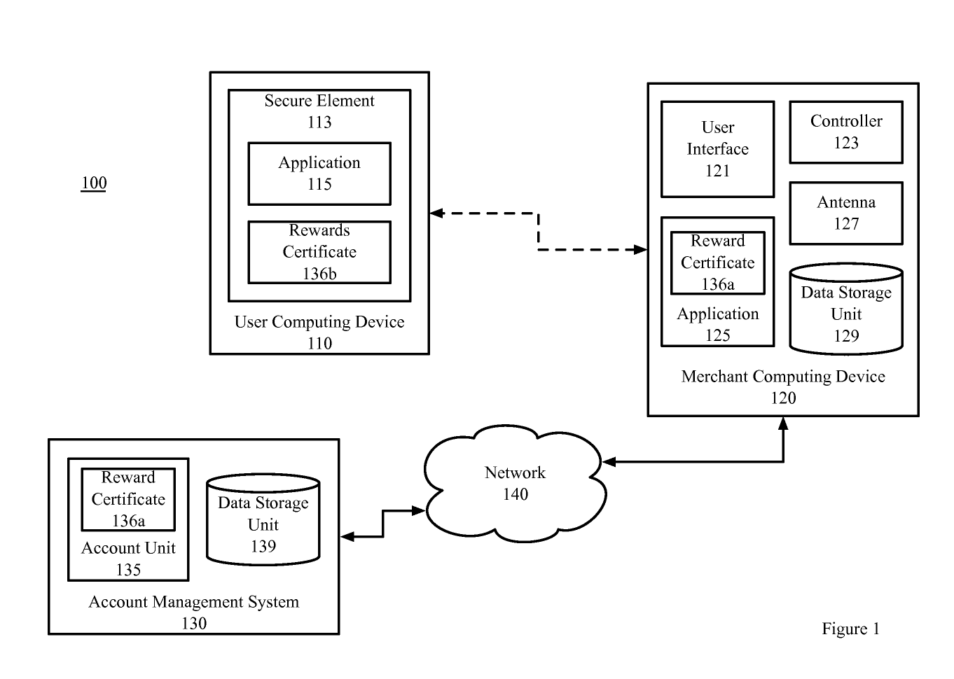

FIG. 1 is a block diagram depicting an offline payment and reward redemption system, in accordance with certain example embodiments. As depicted in FIG. 1, the exemplary operating environment 100 comprises a user computing device 110, a merchant computing device 120, and an account management computing system 130 that are configured to communicate with one another via one or more networks 140. In some embodiments, a user associated with a device must install an application and/or make a feature selection to obtain the benefits of the techniques described herein.

In an example embodiment, the user computing device 110 and the merchant computing device 120 are configured to communicate directly and exchange information without a network 140 connection. In an example embodiment, the devices (including device 120 and 110) communicate via a proximity communication technology. For example, via a near field communication channel, Bluetooth communication, Bluetooth Low Energy (BLE) communication, a form of standardized radio frequency, infrared, sound (for example, audible sounds, melodies, and ultrasound), other short range communication channel, or system that facilitates the communication of signals, data, and/or messages (generally referred to as data). Throughout this specification, it should be understood that the terms “data” and “information” are used interchangeably herein to refer to text, images, audio, video, or any other form of information that can exist in a computer-based environment.

Each network 140 includes a wired or wireless telecommunication means by which network computing systems (including systems/devices 110, 120, and 130) can communicate and exchange data. For example, each network 140 can be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a mobile telephone network, a card network, or any combination thereof, or any other appropriate architecture or system.

In an example embodiment, each network computing system (including systems 110, 120, and 130) includes a device having a communication unit capable of transmitting and receiving data over the network 140. For example, each network computing system (including systems 110, 120, and 130) may comprise a server, personal computer, mobile device (for example, notebook computer, tablet computer, netbook computer, personal digital assistant (PDA), video game device, GPS locator device, cellular telephone, Smartphone, or other mobile device), a television with one or more processors embedded therein and/or coupled thereto, or other appropriate technology that includes or is coupled to a web browser or other application for communicating via the network 140. In the example embodiment depicted in FIG. 1, the network computing systems (including systems 110, 120, and 130) are operated by users, merchants, and an account management system operator, respectively.

In an example embodiment, the merchant computing device 120 can refer to a smart communication device that can communicate via an electronic, magnetic, or radio frequency field between the device 120 and another device, such as a user computing device 110. In an example embodiment, the merchant computing device 120 has processing capabilities, such as storage capacity/memory and one or more applications 125 that can perform a particular function. In an example embodiment, the merchant computing device 120 comprises an operating system (not illustrated) and user interface 121. Example merchant devices 120 are smart phones, mobile phones, personal digital assistants (PDAs), mobile computing devices (for example, netbooks, tablets, and iPads), laptops, wearable computing devices (for example, watches, rings, or glasses), and other devices, in each case having processing and user interface functionality.

In an example embodiment, the merchant computing device 120 functions as a point of sale (POS) terminal and is capable of processing a purchase transaction initiated by a user of a user computing device 110. In an example embodiment, the user requests a purchase from the merchant computing device 120. The merchant computing device 120 receives or otherwise reads payment account information from the user computing device 110. In an example embodiment, the purchase is initiated by a wireless “tap” of the user computing device 110 with the merchant computing device 120.

The application 125 is a program, function, routine, applet or similar entity that exists on and performs its operations on a merchant computing device 120. For example, the application 125 may be one or more of an offline payment application, a digital wallet application, a coupon application, a loyalty card application, another value-added application, a user interface application, or other suitable application operating on the merchant computing device 120. Additionally, the merchant computing device 120 may comprise a secure element (not illustrated), which can exist within a removable smart chip or a secure digital (SD) card or which can be embedded within a fixed chip on the device 120. In certain example embodiments, Subscribed Identity Module (SIM) cards may be capable of hosting a secure element, for example, an NFC SIM Card. The secure element allows a software application 125 resident on the device 120 and accessible by the device user to interact securely with certain functions within the secure element, while protecting information stored within the secure element. The secure element may comprise one or more applications 125 running thereon that perform the functionality described herein.

The merchant computing device 120 communicates with the user computing device 110 via an antenna 127. In an example embodiment, once the merchant device application 125 has been activated and prioritized, the controller 123 is notified of the state of readiness of the merchant computing device 120 for a transaction. The controller 123 outputs through the antenna 127 a radio signal, or listens for radio signals from the user computing device 110. On establishing a secure communication channel between the merchant computing device 120 and the user computing device 110, the merchant computing device 120 may request a list of applications 115 available from the user computing device 110. A directory is first displayed, after which, based on the set priority or the type of user computing device 110, an application 115 is chosen and initiated for the transaction.

In an example embodiment, the controller 123 is a Bluetooth link controller. The Bluetooth link controller 123 may be capable of sending and receiving data, identifying the user computing device 110, performing authentication and ciphering functions, and directing how the merchant computing device 120 will listen for transmissions from the user computing device 110 or configure the merchant computing device 120 into various power-save modes according to the Bluetooth-specified procedures. In another example embodiment, the controller 123 is a Wi-Fi controller or an NFC controller capable of performing similar functions.

An example merchant computing device 120 comprises one or more keys and/or certificates. In an example embodiment, an offline transaction key is generated by the account management system 130 and transmitted to the merchant computing device 120 for each new session. Each session key can be used only by one merchant computing device 120 for the duration of a single session (for example, for the period of time from when the merchant signs onto a new session until the merchant signs out of the session). In addition, each session key may have a maximum number of transactions allowed per session key or a maximum time period allowed per session key. The session key may become invalid if the maximum is reached and the merchant may be required to start a new session, and thus receive a new session key.

In an example embodiment, the merchant computing device 120 verifies a response received from the user computing device 110 in response to a payment request. The user computing device 110 signs the response using an account certificate and the merchant computing device 120 verifies the response using an account certificate public key to confirm the identity of the user computing device 110. In another example embodiment, the merchant computing device 120 verifies a balance certificate received from the user computing device 110 in response to a payment request. The merchant computing device 120 verifies the balance certificate using a balance certificate public key to confirm the balance certificate is not expired and to confirm the availability of the funds to complete the offline payment transaction. In an example embodiment, the merchant computing device 120 signs the withdrawal record using a merchant device signing certificate and transmits the signed withdrawal record to the user computing device 110 or writes the withdrawal record to the user computing device 110 transaction history.

In an example embodiment, the merchant computing device 120 comprises a reward certificate 136a. An example reward certificate 136a comprises an electronic record or listing of information describing a reward available for redemption by the user. In an example embodiment, the information comprised in the reward certificate 136a notifies the merchant computing device 120 of the availability of the reward, the amount of the reward, the identity of the user computing device 110 associated with the reward, and any limits placed on redemption of the reward. In an example embodiment, each user's reward account is maintained and managed by the account management system 130. In this embodiment, the account management system 130 determines the user's reward balance and the rewards available for redemption with each merchant. The account management system 130 prepares a reward certificate 136a that reflects the rewards available for redemption during a transaction between the user and the merchant. In an example embodiment, the account management system 130 transmits the reward certificate 136a to each merchant computing device 120 operated by the merchant. In another example embodiment, the account management system 130 transmits the reward certificate 136a to one or more merchant computing devices 120 and the reward certificate 136a is replicated onto each merchant computing device 120 operated by the merchant. In an example embodiment, updated reward certificates 136a are transmitted to the merchant computing device each time the merchant computing device 120 establishes a network connection with the account management system 130.

In an example embodiment, the data storage unit 129 may be implemented in a secure element or other secure memory (not shown) on the merchant computing device 120 or may be a separate memory unit resident on the merchant computing device 120. An example data storage unit 129 enables storage of signed withdrawal records and user computing device 110 transaction histories until the merchant computing device 120 has network 140 access and can communicate the records to the account management system 130. In an example embodiment, the data storage unit 129 can include any local or remote data storage structure accessible to the merchant computing device 120 suitable for storing information. In an example embodiment, the data storage unit 129 stores encrypted information, such as HTML5 local storage.

According to an example embodiment, the merchant computing device 120 may connect to network 140 via a wired connection. For example, the connection may be a wired universal serial bus (USB) or Ethernet connection. In another example embodiment, the merchant computing device 120 may connect to the network via a wireless connection. For example, the connection may be a Wi-Fi or Bluetooth connection to a hotspot that has a wired/wireless Internet connection (for example, MiFi), or any other wired or wireless connection suitable for communicating signals with network 140. In another example embodiment, the connection may be a cellular network connection.

The user can use the user computing device 110 to perform an offline payment transaction and/or an offline rewards redemption transaction with the merchant computing device 120. In an example embodiment, the user computing device 110 may be a personal computer, mobile device (for example, notebook, computer, tablet computer, netbook computer, personal digital assistant (PDA), video game device, GPS locator device, cellular telephone, Smartphone or other mobile device), smart card device (for example, MIFARE cards, stored value memory cards, and other types of memory cards), wearable computing devices (for example, watches, rings, or glasses), or other appropriate technology that can communicate via an electronic, magnetic or radio frequency field between the device 110 and another device, such as a merchant computing device 120 or a card reader (not illustrated). In an example embodiment, the user computing device 110 has processing capabilities, such as storage capacity/memory and one or more applications 115 that can perform a particular function. In an example embodiment, the user computing device 110 also has an NFC enabled chip (not illustrated) implemented, either independently or on existing components, within the device 110.

An example user computing device 110 comprises a secure element 113 or secure memory, which can exist within a removable smart chip or a secure digital (SD) card, which can be embedded within a fixed chip on the device 110, or be realized as a secure compartment of a security-enhanced operating system. In certain example embodiments, Subscriber Identity Module (SIM) cards may be capable of hosting a secure element 113, for example, an NFC SIM Card. The secure element 113 allows a software application 115 resident on the device 110 and accessible by the device user to interact securely with certain functions within the secure element 113, while protecting information stored within the secure element 113. The secure element 113 comprises applications running thereon that perform the functionality described herein. In an example embodiment, the secure element 113 comprises components typical of a smart card, such as crypto processors and random generators. In an example embodiment, the secure element 113 comprises a Smart MX type NFC controller in a highly secure system on a chip controlled by a smart card operating system, such as a JavaCard Open Platform (JCOP) operating system. In another example embodiment, the secure element 113 is configured to include a non-EMV type contactless smart card, as an optional implementation. The secure element 113 communicates with the application 115 in the user computing device 110. In an example embodiment, the secure element 113 is capable of storing encrypted user information and only allowing trusted applications to access the stored information. In an example embodiment, a controller (not shown) interacts with a secure key encrypted application 115 for decryption and installation in the secure element 113.

Additionally, the secure element 113 also may comprise secure software applications, such as payment applications, secure forms of the applications 113, authentication applications, payment provisioning applications, or other suitable application using the secure functionality of the secure element 113. The application 115 is a program, function, routine, applet or similar entity that exists on and performs its operations on the user computing device 110. For example, the application 115 may be one or more of a shopping application, merchant system application, an Internet browser, a digital wallet application, a loyalty card application, another value-added application, a user interface application, or other suitable application operating on the user computing device 110. In some embodiments, the user must install an application 115 and/or make a feature selection on the user computing device 110 to obtain the benefits of the techniques described herein.

The user computing device 110 also may comprise one or more keys or certificates. In an example embodiment, the one or more keys control access to the information contained in the user computing device 110. For example, security measures can include password keys and logic that are hard-coded into the user computing device 110 by the manufacturer. In an example embodiment, access keys contained on the user computing device 110 are also used for mutual authentication between the user computing device 110 and the merchant computing device 120. For example, a user computing device 110 which does not comprise a correct access key will not be authenticated by the merchant computing device 120. As a result, the transaction will be rejected. In another example embodiment, a symmetric key may be utilized to encrypt the data on the user computing device 110, so that an NFC-enabled device without such a key cannot comprehend the data on the user computing device 110. The key is shared with the account management system 130 and the merchant computing device 120.

In an example embodiment, a monotonic counter or monotonic register may also be implemented in a secure element 113 on the user computing device 110. Registers may store the number of times a particular event or process has occurred. An example register is monotonic and thus, only allows for the values to be increased or incremented, not decreased. This preventative measure prevents users from saving the current state of a user computing device 110, using the card and then rolling the device 110 back to the previously saved state, thereby receiving a free transaction. An example embodiment, a sum of deposits and a sum of withdrawals are stored in the monotonic register. The sum of deposits and sum of withdrawals can be compared to the saved transaction history on the user computing device 110 when a transaction is requested. Because the sum of deposit and/or sum of withdrawals are store in the monotonic register (which can only be incremented, not decreased), a user computing device 110 that has been rolled back to a previous state can be detected and inactivated.

In another example embodiment, a monotonic register is increased during each withdrawal transaction and the total number of withdrawal transactions saved in the transaction history is compared to the number designated by the monotonic register. Likewise, a monotonic register may be increased during each deposit transaction and the total number of deposit transactions saved in the transaction history is compared to the number designated by the monotonic register.

In an example embodiment, the user computing device 110 comprises a rewards certificate 136b. An example rewards certificate 136b comprises an up-to-date transaction record of all reward redemption transactions. In another example embodiment, the rewards certificate 136b comprises a reward balance or reward redemption balance. In an example embodiment, the reward certificate 136b is increased during each reward redemption transaction and the total number of reward redemption transactions saved in the transaction history is compared to the number designated by the monotonic register.

In another example embodiment, an application (not illustrated) operates outside of the secure element 113 on the user computing device 110. In an example embodiment, this application receives the payment request from the merchant computing device 120 and evaluates the payment request to determine whether the payment request should be forwarded to the secure element 113 for processing. In this embodiment, the application employs monotonic counters or monotonic registers, key operations, table lookups (for example, reviewing tables comprising granted rewards and/or redeemed rewards), and other forms of fraud prevention when evaluating the payment request.

In an example embodiment, the merchant computing device 120 communicates with the account management system 130 via the network 140. In an example embodiment, the merchant computing device 120 transmits withdrawal records and/or the transaction history for the user computing device 110 to the account management system 130 when the merchant computing device 110 regains network 140 access. An example account management system 130 comprises an account unit 135 that maintains an account for the user. In an example embodiment, the account management system 130 stores the user's financial transactions made using the user's account management system 130 account (for example, each deposit of funds and each withdrawal of funds for each account) in the account unit 135. In an example embodiment, the account management system 130 analyzes the transaction history to identify missing data or possible errors.

In an example embodiment, the user account further comprises a reward transaction history and reward balance for one or more merchants. In this embodiment, the account management system 130 receives notifications from the merchant computing device 120 for each purchase transaction that is completed by the user computing device 110. The merchant has created, enrolled, or authorized a reward, loyalty, or other redemption program that is maintained by the account management system 130. In this embodiment, the account management system 130 reviews the notifications received from the merchant computing device 120 and updates the user's reward balance for each qualifying transaction completed. In an example embodiment, the account management system 130 maintains the user's reward balance in a reward certificate 136a.

The data storage unit 139 can comprise any local or remote data storage structure accessible to the account management system 130 suitable for storing information. In an example embodiment, the data storage unit 139 stores encrypted information, such as HTML5 local storage.

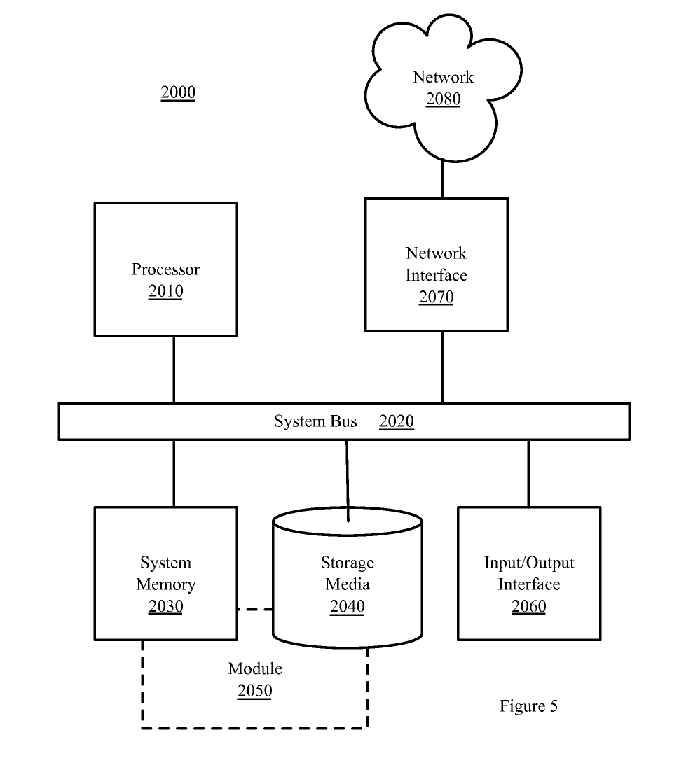

In example embodiments, the network computing devices and any other computing machines associated with the technology presented herein may be any type of computing machine such as, but not limited to, those discussed in more detail with respect to FIG. 5. Furthermore, any units associated with any of these computing machines, such as units described herein or any other units (scripts, web content, software, firmware, or hardware) associated with the technology presented herein may by any of the units discussed in more detail with respect to FIG. 5. The computing machines discussed herein may communicate with one another as well as other computer machines or communication systems over one or more networks, such as network 140. The network 140 may include any type of data or communications network, including any of the network technology discussed with respect to FIG. 5.

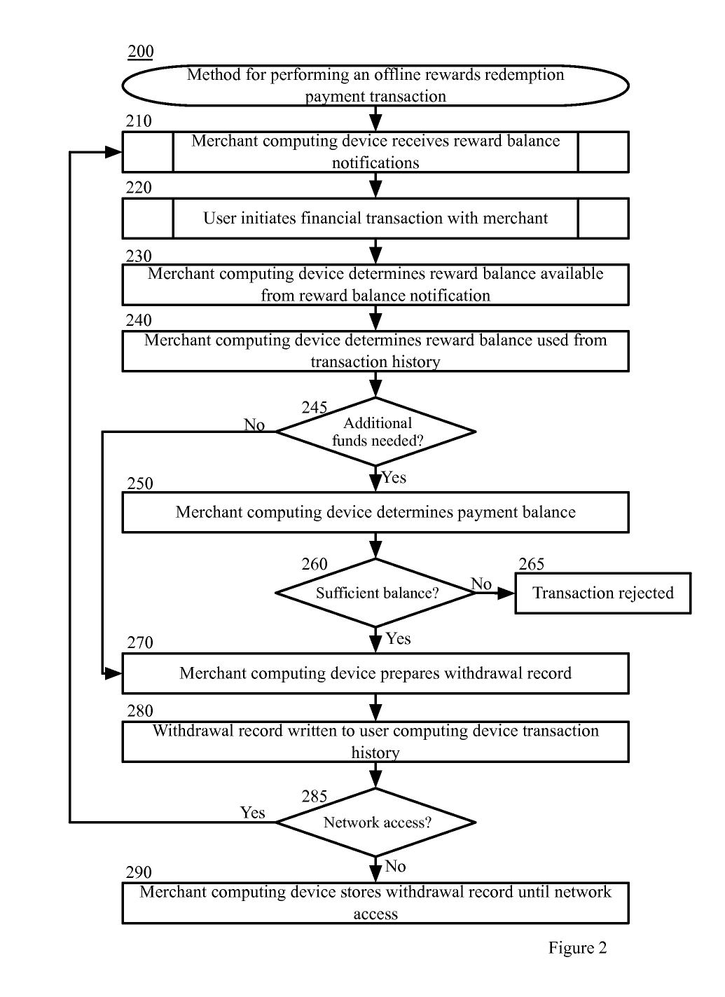

The components of the example-operating environment 100 are described hereinafter with reference to the example methods illustrated in FIGS. 2-4. The example methods of FIGS. 2-4 may also be performed with other systems and in other environments.

### Example System Processes

FIG. 2 is a block flow diagram depicting a method for performing an offline rewards redemption payment transaction, in accordance with certain example embodiments. The method 200 is described with reference to the components illustrated in FIG. 1.

In block 210, the merchant computing device 120 receives reward balance notifications from the account management system 130. In an example embodiment, the reward balance notifications comprise one or more reward certificates 136a for one or more different users. In an example embodiment, the merchant enrolls in, establishes, subscribes to, authorizes, creates, or otherwise enables a loyalty rewards program maintained and managed by the account management system 130. In this embodiment, the account management system 130 maintains a record, list, and/or account for each user. In this embodiment, the account management system 130 determines each qualifying transaction between the user computing device 110 and the merchant computing device 120 and maintains a record in the user's account management system 130 account. The account management system 130 is then able to determine the user's reward balance as it corresponds to the merchant.

In an example embodiment, the user enables a feature on the user computing device 110 and/or indicates a desire to perform offline financial payment transactions. In an example embodiment, the user enables the application 115 to allow the user computing device 110 to perform an offline payment transaction with the merchant computing device 120. In another example embodiment, the user enables a feature and/or indicates a desire to create an account management system 130 account. In this embodiment, the user indicates a desire to enroll in or participate in a merchant loyalty program. In another example embodiment, the user is enrolled as a “guest” user without providing personal enrollment information.

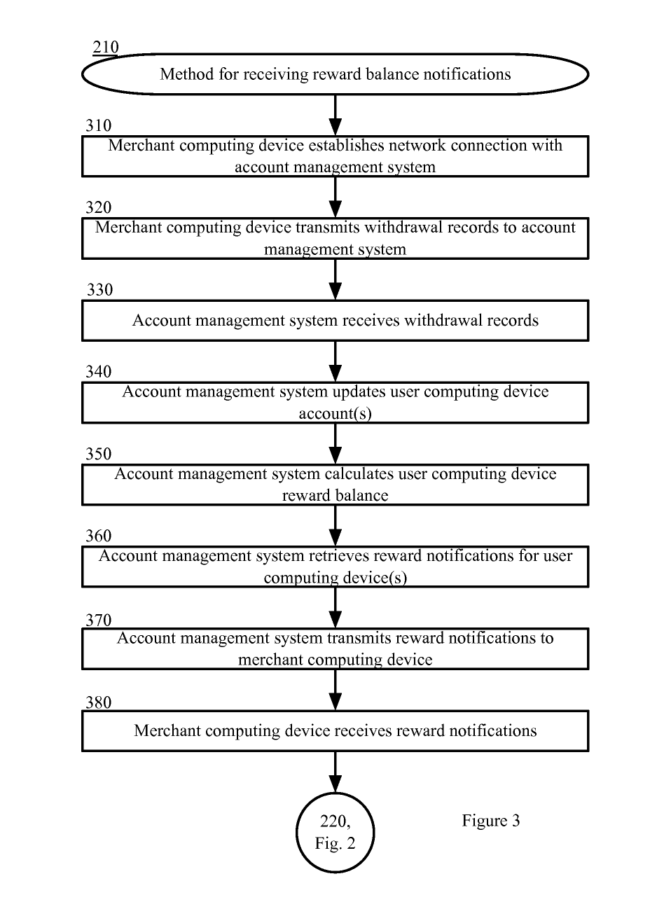

The method for receiving reward balance notifications is described in more detail hereinafter with reference to the methods described in FIG. 3.

FIG. 3 is a block flow diagram depicting a method 210 for receiving reward balance notifications, in accordance with certain example embodiments, as referenced in block 210. The method 210 is described with reference to the components illustrated in FIG. 1.

In an example embodiment, the merchant computing device 120 receives the reward balance notifications during any communication with the account management system 130. In an example embodiment, the communications comprise transmission of a user computing device 110 withdrawal record, transmission of a user computing device 110 transaction history, transmission of a request to start a new merchant computing device 120 session, enrollment in a loyalty reward program, or any other communication with the account management system. In an example embodiment, a network connection is required to communicate with the account management system 130.

In an example embodiment, the merchant is required to start a new session when logging onto the merchant computing device 120. In another example embodiment, the merchant is required to start a new session when a maximum number of transactions or time limit has been reached since the previous session was started.

In block 310, the merchant computing device establishes a network 140 connection with the account management system 130.

In block 320, the merchant computing device 120 transmits one or more withdrawal records to the account management system 130. In an example embodiment, a withdrawal record comprises a listing, record, and/or description of an offline payment transaction between the merchant computing device 120 and a user computing device 110. In this embodiment, the payment transaction occurs offline or without a network 140 connection between the merchant computing device 120 and the account management system 130. In this embodiment, the user computing device 110 presents financial account information that is maintained by the account management system 130 (for example, a pre-paid financial account). The user deposits funds to the user's account management system 130 account for use during an offline payment transaction (for example, a metro payment transaction, where the merchant computing device 120 is unable to obtain a network 140 connection).

The merchant computing device 120 initiates, performs, and authorizes completion of the payment transaction without authorization or verification of available funds from the account management system 130. In this embodiment, the account management system 130 receives a record of the offline payment transaction performed via the withdrawal records transmitted by the merchant computing device 120. In an example embodiment, the merchant computing device 120 transmits a transaction history received from the user computing device 110. In this embodiment, the transaction history comprises a record of each withdrawal and deposit transaction that the user computing device 110 completed. In an exemplary embodiment, the merchant computing device 120 also transmits user account identification information to the account management system 130. In this embodiment, the user account identification information comprises a user computing device 110 account identifier, a financial account identifier, a user account identifier, or other form of identification that allows the account management system 130 to identify the user's account management system 130 account. The user account information may be incorporated into the corresponding withdrawal record.

In an example embodiment, the merchant computing device 120 saves each withdrawal record and/or transaction history until the device 120 has network 140 access and can communicate with the account management system 130.

In block 330, the account management system 130 receives the withdrawal records.

In block 340, the account management system 130 identifies the user's account management system 130 account and updates the user's account with the information received from the merchant computing device 120. In an example embodiment, the account management system 130 cross-references the user account identifier with a listing of user account management system 130 accounts to identify the user's account.

In an example embodiment, the account management system 130 verifies each withdrawal record received and/or synchronizes the user computing device 110 transactions.

In this embodiment, the account management system 130 determines whether one or more offline payment transactions have occurred without transmission of the corresponding withdrawal records. For example, the user computing device 110 performed two withdrawal transactions, one with merchant X and then one with merchant Z. Merchant Z established a connection with the account management system 130 first and transmitted the user computing device 110 transaction history and the withdrawal record for the second transaction. The transaction history lists both transaction, but the account management system 130 only has a withdrawal record for the transaction with merchant Z. Accordingly, the account management system 130 can determine, based on the transaction history, that the user computing device 110 was involved in an earlier withdrawal transaction and can update the user's account management system 130 account accordingly.

In block 350, the account management system calculates the user computing device 110 reward balance. In an example embodiment, the account management system 130 enters the withdrawal record into the user's account management system 130 account and updates the user's reward balance. In an example embodiment, the merchant's reward program comprises a tally of a number of transactions required to receive a reward. For example, the user receives a reward after ten successful transactions. In this embodiment, the account management system 130 updates the reward balance to add an additional transaction. In another example, the merchant's reward program comprises a minimum transaction amount spent to receive a reward. For example, the user receives a reward after spending $100. In this embodiment, the account management system 130 updates the reward balance to add the transaction amount from the withdrawal record.

In an example embodiment, once the user reaches the reward threshold, or minimum reward balance required for redemption, the account management system 130 prepares a reward certificate 136a. An example reward certificate 136a comprises a notification or certification of the reward ready for redemption by the user computing device 110. For example, the user has reached the $100 minimum transaction balance and has received a reward for $10 off the user's next purchase transaction. In this example, the reward certificate 136a comprises a notification that the user computing device 110 has a $10 credit for use in the next purchase transaction. In an example embodiment, the reward certificate 136a comprises an identification of the user computing device 110 and/or the user identification used by the merchant computing device 120 to identify the device 110 during a payment transaction.

In block 360, the account management system 130 retrieves all reward notifications that correspond to the merchant computing device 120. In this embodiment, the account management system 130 identifies all reward notifications that have yet to be sent to the merchant computing device 120. For example, merchant Z has five different merchant computing devices 120. Merchant computing device A transmitted a withdrawal record for User T that qualified User T to receive a reward. The account management system 130 transmitted the reward certificate 136a for User T to merchant computing device A. However, the remaining merchant computing devices belonging to merchant Z have not yet received the reward certificate 136a for User T. Accordingly, when merchant computing device B establishes its next network connection with the account management system 130, the system 130 transmits the reward certificate 136a for User T to merchant computing device B.

In block 370, the account management system 130 transmits the reward notifications to the merchant computing device 120. In an example embodiment, the reward notifications comprise reward certificates 136a. In an example embodiment, the reward certificates 136a are records comprising one or more rewards available for redemption by one or more user computing devices 110 during an offline payment transaction. In an example embodiment, the account management system 130 also notifies the user of the available reward. In this embodiment, the account management system 130 transmits an electronic message, alert, SMS message, or other notification to the user computing device 110 via the network 140.

In block 380, the merchant computing device 120 receives the reward notifications. In an example embodiment, the merchant computing device 120 saves the reward certificates 136a. In this embodiment, the merchant computing device 120 retrieves the reward certificates 136a in the data storage unit 129 when completing an offline payment transaction with a user computing device 110.

The method 210 then proceeds to block 220 in FIG. 2.

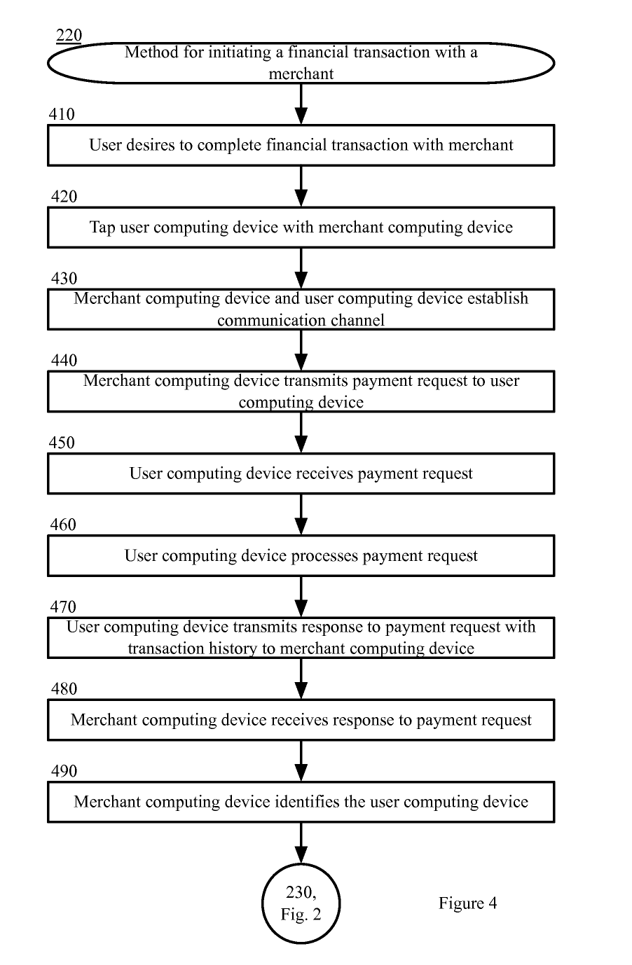

In block 220, the user initiates a financial transaction with the merchant. In an example embodiment, the financial transaction is an offline payment transaction where the merchant computing device 120 is without a network 140 connection to the account management system 140 or other system maintaining an account for the user. In this embodiment, the merchant computing device 120 processes and authorizes the offline payment transaction without receiving notification, confirmation, or verification from an issuer system or account management system 130 that sufficient funds are available to authorize with the offline payment transaction. The method for initiating a financial transaction with a merchant is described in more detail hereinafter with reference to the methods described in FIG. 4.

FIG. 4 is a block flow diagram depicting a method 220 for initiating a financial transaction with a merchant, in accordance with certain example embodiments, as referenced in block 220. The method 220 is described with reference to the components illustrated in FIG. 1.

In block 410, the user indicates a desire to complete a financial transaction with the merchants. In an example embodiment, the user has indicated a desire to complete an offline payment transaction with the merchant. In an example embodiment, the user accesses an application 115 on the user computing device 110 that enables the user computing device 110 to perform an offline payment transaction. In an example embodiment, the user accesses an application 115 that enables the user computing device 110 to wirelessly communicate with the merchant computing device 120. In this embodiment, the devices (including devices 110 and 120) communicate via a secure communication channel (for example, near field communications, Bluetooth, Wi-Fi, or other form of wireless communication channel). In another example embodiment, the user computing device 110 comprises a smart card device 110 and the user indicates a desire to complete an offline payment transaction by presenting the device 110 to the merchant.

In block 420, the user taps the user computing device 110 with the merchant computing device 120. In an example embodiment, the user “taps” the user computing device 110 in the proximity of the merchant computing device 120. In another example embodiment, the merchant computing device 120 generates a radio frequency (RF) or other field polling for the presence of a user computing device 110, and the user “taps” the user computing device 110 by placing the device 110 within the field of the merchant computing device 120. In another exemplary embodiment, the merchant activates the RF field or other field to poll for the presence of a user computing device 110 using an application 125 on the merchant computing device 120.

In block 430, the merchant computing device 120 and the user computing device 110 establish a communication channel. In an example embodiment, the communication channel is established without a network 140 connection to the account management system 130.

In an example embodiment, the merchant computing device 120 requests protocols and characteristics from the user computing device 110 during the establishment of the communication channel. For example, the merchant computing device 120 may request the identification of communication protocols (for instance ISO/IEC 14443, MIFARE, and/or ISO/IEC 18092), a list of applications 115 available, a user identification information (for instance a user account number), and security protocols from the user computing device 110. In an example embodiment, the merchant computing device 120 may request verification information for the user computing device 110 for mutual authentication between the user computing device 110 and the merchant device 120.

In an example embodiment, the user computing device 110 transmits the requested protocols and characteristics to the merchant computing device 120. In an example embodiment, the user identification information is encoded and stored in the secure element 113 of the user computing device 110 and not visible or otherwise written on the physical device 110. The requested information is extracted and transmitted to the merchant computing device 120 via the secure communication channel. In an example embodiment, the secure communication channel is between the merchant computing device 120 application 125 and the user computing device 110 secure element 113.

In an example embodiment, the user computing device 110 transmits the device's transaction history as part of the communication set up. In another example embodiment, the transaction history is transmitted with a payment request response.

In block 440, the merchant computing device 120 transmits a payment request to the user computing device 110. In an example embodiment, the merchant enters a payment request amount into the application 125 on the merchant computing device 120. In this embodiment, the payment request comprises an identification of the merchant computing device 120, a payment request amount, and/or a timestamp. In an example embodiment, the payment request is transmitted via the secure communication channel.

In block 450, the user computing device 110 receives the payment request from the merchant computing device 110. In an example embodiment, the secure element 113 receives the payment request.

In block 460, the user computing device 110 processes the payment request. In an example embodiment, the user computing device 110 generates a withdrawal record or other response to the payment request for an amount indicated on the payment request received from the merchant computing device 120. In an example embodiment, the withdrawal record comprises information received in the payment request (for example, an identification of the merchant or merchant device 120, a payment request amount, and a timestamp). In another example embodiment, the withdrawal record comprises an identification of the user computing device 110, an identification of the user, and/or an identification of the user's account management system 130 account. In another example embodiment, the user may change the payment request amount using the application 115 prior to or while the withdrawal record is created. The withdrawal record also can comprise combinations of any of the information described above.

In an example embodiment, the user computing device 110 signs the withdrawal record to allow the merchant computing device 120 to verify that the account information (for example, the account management system 130 account) belongs to the user and is authorized for use in the offline payment transaction. In another example embodiment, the user computing device 110 payment request response comprises a balance certificate signed by the account management system 130. In this example embodiment, the user computing device 110 confirms the availability of funds for the offline payment transaction by cross-referencing the payment request amount with the amount of funds available for an offline payment transaction disclosed by the balance certificate. In another example embodiment, the user computing device reviews any rules or limits placed on the amount of funds available for an offline payment transaction and determines if the payment transaction meets those rules.

In block 470, the user computing device 110 transmits the payment request response to the merchant computing device 120. In an example embodiment, the payment request response comprises the user computing device 110 transaction history. In this embodiment, the merchant computing device 120 calculates the user computing device 110 available balance using the transaction history. In another example embodiment, the payment request response further comprises a reward certificate 136b indicating a listing or each reward redeemed by the user computing device 110. An example reward certificate 136b is updated by the merchant computing device 120 each time the user computing device 110 completes a reward redemption transaction. In another example embodiment, the reward redemption transactions are transmitted as part of the transaction history. In an example embodiment, the payment request response is transmitted via the secure communication channel.

In block 480, the merchant computing device 120 receives the payment request response from the user computing device 110.

In block 490, the merchant computing device 120 identifies the user computing device 110. In an example embodiment, the merchant computing device 120 reviews the user identification information transmitted by the user computing device 110 when the communication channel is established or transmitted as a part of the payment request response. In an example embodiment, the merchant computing device 120 reviews the identification information to determine the identity of the user computing device 110. In this embodiment, the determined identity of the user computing device 110 corresponds to a reward certificate 136a received from the account management system 130. In another example embodiment, the merchant computing device 120 verifies the signature on the payment request response using a public key pair.

The method 220 then proceeds to block 230 in FIG. 2.

Returning to FIG. 2, in block 230, the merchant computing device 120 determines the reward balance available for the user computing device 110. In an example embodiment, the merchant computing device 120 retrieves the saved reward certificates 136a and determines whether a reward certificate 136a corresponds to the user computing device 110. In this embodiment, the merchant computing device 120 identifies the reward certificate 136a and determines the reward balance for the user computing device 110. For example, the merchant computing device 120 identifies the reward certificate for User T and identifies that User T gets $10 off a transaction.

In an example embodiment, the reward certificate 136a comprises an up-to-date listing of the rewards available to redemption, but may not reflect the rewards redeemed by the user computing device 110. In this embodiment, the merchant computing device 120 must compute the available rewards by reading the reward certificate 136b from the user computing device 110.

In block 240, the merchant computing device 120 determines a reward balance redeemed previously by the user computing device 110. In an example embodiment, the merchant computing device 120 reads the redemption transactions from the reward certificate 136b received from the user computing device 110. In this embodiment, the reward certificate 136b on the user computing device 110 is updated to reflect each reward redemption transaction. By determining a reward balance redeemed from the reward certificate 136b, the merchant computing device 120 can determine whether the user computing device 110 has previously redeemed the merchant reward available during a purchase transaction with another merchant computing device 120. For example, merchant Z has five different merchant computing devices 120. Merchant computing device A completed a redemption transaction with User T to redeem the $10 off transaction. User T engages in an offline payment transaction with merchant computing device T, but merchant computing device B has not communicated with the account management system 130 to receive an updated reward certificate 136a reflecting the redeemed reward. According to the reward certificate 136a that merchant computing device B has, the user has a $10 off reward available for redemption. However, merchant computing device A wrote a redemption transaction to the reward certificate 136b resident on the user computing device 110 indicating the redemption transaction (as described in more detail hereinafter with reference to block 280 of FIG. 2). Accordingly, merchant computing device B can determine that the user has already redeemed the $10 off reward.

In block 245, the merchant computing device 120 determines whether additional funds are required to complete the offline payment transaction. In an example embodiment, the merchant computing device 120 calculates the transaction total and subtracts the amount of reward available for redemption. For example, User T engages in a $30 offline payment transaction with merchant computing device A. User T has a $10 off reward available for redemption. Merchant computing device A determines that User T has not yet redeemed the reward. Merchant computing device A subtracts the $10 available reward from the $30 transaction total and determines that User T needs $20 more to complete the offline payment transaction.

If the user does not need additional funds to complete the payment transaction, the method 200 proceeds to block 270 in FIG. 2.

Returning to block 245, if the user needs additional funds to complete the payment transaction, the method 200 proceeds to block 250 in FIG. 2. In block 250, the merchant computing device determines the payment balance. In an example embodiment, the merchant computing device 120 calculates the transaction total and subtracts the amount of reward available for redemption. In an example embodiment, the merchant computing device 120 adjusts the purchase price of the transaction to reflect the determined payment balance. In another example embodiment, the merchant computing device 120 determines the reward certificate 136a balance prior to transmission of the payment request to the user computing device 110. In this embodiment, the merchant computing device 120 computes the additional funds required to complete the offline payment transaction and then transmits a payment request in the amount of the additional funds required.

In block 260, the merchant computing device 120 determines whether the user computing device 110 has a sufficient balance to complete the offline payment transaction. In an example embodiment, the balance must be greater than or equal to the adjusted purchase price.

In an example embodiment, the merchant computing device 120 reads the deposit transactions written in the transaction history on the user computing device 110. In an example embodiment, the merchant computing device 120 uses an access key 129 to read the current deposit transactions. The merchant computing device 120 then calculates the sum of deposits.

In an example embodiment, a deposit transaction is recorded as:

D1: sum of deposits before this transaction

D2: sum of deposits after this transaction

Notation: +,D1→D2

In another example embodiment, the merchant computing device 120 reads the sum of deposits from a monotonic counter and compares the sum of deposits calculated to the sum of deposits read from the monotonic counter. If these numbers do not match, an error is displayed and the transaction is rejected.

In an example embodiment, the merchant computing device 120 reads the withdrawal transactions written in the transaction history on the user computing device 110. In an example embodiment, the merchant computing device 120 uses a key to read the current withdrawal transactions. The merchant computing device 120 then calculates the sum of withdrawals.

In an example embodiment, a withdrawal transaction is recorded as:

W1: sum of withdrawals before this transaction

W2: sum of withdrawals after this transaction

Notation: −,W1→W2

In another example embodiment, the merchant computing device 120 reads the sum of withdrawals from the monotonic counter and compares the sum of withdrawals calculated to the sum of withdrawals read from the monotonic counter. If these numbers do not match, an error is display and the transaction is rejected.

In an example embodiment, the merchant computing device 120 determines the user computing device 110 balance by subtracting the sum of deposits from the sum of withdrawals. If the sum of withdrawals is less than or equal to the sum of deposits, the user computing device 110 has a sufficient balance for the offline payment transaction. In an example embodiment, the merchant computing device 120 can calculate the lower boundary of the card balance. For example:

Balance≧last known sum of deposits−last known sum of withdrawals

For example, using the following transaction history:

| | +, 0→0 |
|---|---|
| A account is created with zero balance | −, 0→0 |
| Deposit 20 | +, 0→20 |
| Withdraw 4 | −, 0→4 |
| Withdraw 8 | −4→12 |
| Deposit 10 | +20→30 |
| Withdraw 7 | −, 12→19 |
| Withdraw 2 | −, 19→21 |

the current user computing device 110 balance can be calculated using the last deposit and withdrawal transactions:

+,20→30

−,19→21

Balance=30−21=9

If the user computing device 110 does not have sufficient balance for the offline payment transaction, the method 200 proceeds to block 265 in FIG. 2. In block 265, the transaction is rejected. In an example embodiment, the user computing device 110 cannot maintain a negative account balance. Accordingly, a withdrawal transaction cannot exceed the sum of deposits.

Returning to block 260 in FIG. 2, if the user computing device 110 does have a sufficient balance for the offline payment transaction, the method 200 proceeds to block 270 in FIG. 2. In block 270, the merchant computing device 120 prepares a withdrawal record. In an example embodiment, the withdrawal record comprises a listing of the purchase transaction amount, the reward redeemed, the adjusted purchase transaction amount, an identity of the merchant computing device 120, and/or an identity of the user computing device 110. In another example embodiment, the merchant computing device 120 prepares a reward redemption record. In this embodiment, the reward redemption record comprises a listing of the reward redeemed, the redemption amount, an identity of the merchant computing device 120, and/or an identity of the user computing device 110. In an example embodiment reward redemption record is a part of the withdrawal record. In another example embodiment, the reward redemption record is link to, but separate from, the withdrawal record.

In block 280, the merchant computing device 120 writes the withdrawal record to the user computing device 110 transaction history. In an example embodiment, the merchant computing device 120 comprises a key that allows the device 120 to access, read, and write withdrawal records to the user computing device 110 transaction history. In an another example embodiment, the merchant computing device 120 does not need a key to allow it to modify, erase, or remove records previously written to the transaction history.

In an example embodiment, the merchant computing device 120 increments the monotonic counter resident on the user computing device 110. In an example embodiment, the access key resident on the merchant computing device 120 is utilized to increment the monotonic counter. In an example embodiment, the monotonic counter may be incremented by the amount of the withdrawal transaction. In another example embodiment, the monotonic counter may be incremented by a fixed number representing the withdrawal transaction. For example, for each withdrawal transaction, the monotonic counter may be incremented by one. In an example embodiment, the monotonic counter is capable only of being increased, not decreased.

In an example embodiment, the merchant computing device 120 writes a reward redemption record to the reward certificate 136b as part of writing the withdrawal record to the user computing device 110. In this embodiment, the reward certificate 136b is updated to reflect the reward redemption and to prevent the reward from being redeemed more than once.

In an example embodiment, the communication channel between the merchant computing device 120 and the user computing device 110 is terminated and the offline purchase transaction is completed once the transaction history and/or reward certificate 136b is updated.

In block 285, the merchant computing device 120 determines whether it has network 140 access. In an example embodiment, network 140 access is required to communicate with the account management system 130.

If the merchant computing device 120 has network 140 access, the method 200 proceeds to block 210 in FIG. 2 and the merchant computing device 120 establishes a network 140 connection with the account management system 130, transmits the withdrawal records, transaction history, and user identification information to the account management system 130.

Returning to block 285 in FIG. 2, if the merchant computing device 120 does not have network 140 access, the method 200 proceeds to block 290 in FIG. 2. In block 290, the merchant computing device 120 stores the withdrawal record, transaction history, and user identification information until it has network 140 access and can communicate with the account management system 130. When network 140 access becomes available, the method 200 proceeds to block 210 in FIG. 2.

### Other Example Embodiments

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (ROM), programmable read-only memory (PROM), erasable programmable read-only memory (EPROM), flash memory, or any other device capable of storing program instructions or data with or without applied power. The system memory 2030 may also include volatile memories such as random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (SOC), system on package (SOP), or ASIC device.

In situations in which the systems discussed here collect personal information about users, or may make use of personal information, the users may be provided with an opportunity or option to control whether programs or features collect user information (e.g., information about a user's activities, a user's preferences, or a user's purchases), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to redeem rewards during offline payment transactions, comprising:
establishing, by a merchant mobile communication device, a network connection with a computer managing a user computing device account;
receiving, by the merchant mobile communication device and from the computer managing the user computing device account, a reward certificate, the reward certificate comprising a reward available for redemption during an offline payment transaction with the user computing device;
establishing, by the merchant mobile communication device, a communication channel with the user computing device while the merchant mobile communication device is without a network connection to the computer managing the user computing device account;
receiving, by the merchant mobile communication device and from the user computing device, a user computing device transaction history comprising a listing of previous deposit transactions, a listing of previous withdrawal transactions, and an amount of previous reward redemptions;
determining, by the merchant mobile communication device, an available reward balance using the reward certificate and the amount of previous reward redemptions;
authorizing, by the by the merchant mobile communication device and without a network connection to the computer managing the user computing device account, an offline reward redemption transaction in response to determining that the available reward balance is less than or equal to a difference between an amount of the reward certificate and the amount of previous reward redemptions;
creating, by the merchant mobile communication device, an offline reward redemption transaction record subtracting the available reward balance from a user computing device reward balance; and
writing, by the merchant mobile communication device, the offline reward redemption transaction record to the user computing device transaction history.

2. The computer-implemented method of claim 1, further comprising:
calculating, by the merchant mobile communication device, a current offline transaction amount using a transaction amount and the available reward balance;
calculating, by the merchant mobile communication device, an amount of previous withdrawals using the listing of previous withdrawal transactions and an amount of previous deposits using the listing of previous deposit transactions; and
authorizing, by the by the merchant mobile communication device and without a network connection to the computer managing the user computing device account, an offline debit transaction in response to determining that the current offline transaction amount is less than or equal to a difference between the amount of previous deposits and the amount of the previous withdrawals.

3. The computer-implemented method of claim 2, wherein the offline reward redemption transaction record further comprises the current offline transaction amount, and wherein the merchant mobile communication device writes the current offline transaction amount to the user computing device transaction history.

4. The computer-implemented method of claim 2, wherein calculating the amount of previous deposits comprises:
sorting deposit transactions in order of deposit from a previous deposit D(n−1) to a latest deposit D(n); and
reviewing the latest deposit transaction to identify the amount of previous deposits.

5. The computer-implemented method of claim 2, wherein calculating the amount of previous withdrawals comprises:
sorting withdrawal transactions in order of withdrawal from a previous withdrawal W(n−1) to a latest withdrawal W(n); and
reviewing the latest withdrawal transaction to identify the amount of previous withdrawals.

6. The computer-implemented method of claim 1, further comprising:
establishing, by the merchant mobile communication device, a second network connection with the computer managing the user computing device account after completing the offline redemption transaction with the user computing device, without the network connection to the computer, and
transmitting, by the merchant mobile communication device, the user computing device transaction history and the offline reward redemption transaction to the computer managing the user computing device account after establishing the second network connection.

7. The computer-implemented method of claim 6, further comprising receiving, by the merchant mobile communication device and from the computer managing the user computing device account, a second reward certificate comprising a second reward available for redemption during an second offline payment transaction with the user computing device.

8. The computer-implemented method of claim 6, wherein the computer managing the user computing device account updates the user computing device account to reflect the reward redemption transaction.

9. A computer program product, comprising:
a non-transitory computer-readable medium having computer-readable program instructions embodied therein that when executed by a computer cause the computer to redeem rewards during offline payment transactions, the computer-readable program instructions comprising:
computer-readable program instructions to establish a network connection between a merchant mobile communication device and a computer managing a user computing device account;
computer-readable program instructions to receive, from the computer managing the user computing device account, a reward certificate, the reward certificate comprising a reward available for redemption during an offline payment transaction with the user computing device;
computer-readable program instructions to establish a communication channel between the merchant mobile communication device and the user computing device while the merchant mobile communication device is without a network connection to the computer managing the user computing device account;
computer-readable program instructions to receive, from the user computing device, a user computing device transaction history comprising a listing of previous deposit transactions, a listing of previous withdrawal transactions, and an amount of a previous reward redemptions
computer-readable program instructions to determine an available reward balance using the reward certificate and the amount of previous reward redemption;
computer-readable program instructions to authorize, without a network connection to the computer managing the user computing device account, an offline reward redemption transaction in response to determining that the available reward balance is less than or equal to a difference between an amount of the reward certificate and the amount of the previous reward redemptions;
computer-readable program instructions to create an offline reward redemption transaction record subtracting the available reward balance from a user computing device reward balance; and
computer-readable program instructions to write the offline reward redemption transaction record to the user computing device transaction history.

10. The computer program product of claim 9, further comprising:
computer-readable program instructions to calculate a current offline transaction amount using a transaction amount and the available reward balance;
computer-readable program instructions to calculate an amount of previous withdrawals using the listing of previous withdrawal transactions and an amount of previous deposits using the listing of previous deposit transactions; and
computer-readable program instructions to authorize, without a network connection to the computer managing the user computing device account, an offline debit transaction in response to determining that the current offline transaction amount is less than or equal to a difference between the amount of previous deposits and the amount of the previous withdrawals.

11. The computer program product of claim 10, wherein the offline reward redemption transaction record further comprises the current offline transaction amount, and wherein the merchant mobile communication device writes the current offline transaction amount to the user computing device transaction history.

12. The computer program product of claim 9, further comprising:
computer-readable program instructions to establish a second network connection with the computer managing the user computing device account after completing the offline redemption transaction with the user computing device, without the network connection to the computer, and
computer-readable program instructions to transmit the user computing device transaction history and the offline reward redemption transaction to the computer managing the user computing device account after establishing the second network connection.

13. The computer program product of claim 12, further comprising computer-readable program instructions to receive, from the computer managing the user computing device account, a second reward certificate comprising a second reward available for redemption during an second offline payment transaction with the user computing device.

14. A system to redeem rewards during offline payment transactions, comprising:
a storage device; and
a processor communicatively coupled to the storage device, wherein the processor executes application code instructions that are stored in the storage device to cause the system to:
establish a network connection between a merchant mobile communication device and a computer managing a user computing device account;
receive, from the computer managing the user computing device account, a reward certificate, the reward certificate comprising a reward available for redemption during an offline payment transaction with the user computing device;
establish a communication channel between the merchant mobile communication device and the user computing device while the merchant mobile communication device is without a network connection to the computer managing the user computing device account;
receive, from the user computing device, a user computing device transaction history comprising an amount of a previous reward redemption;
determine an available reward balance using the reward certificate and the amount of previous reward redemptions;
authorize, without a network connection to the computer managing the user computing device account, an offline reward redemption transaction in response to determining that the available reward balance is less than or equal to a difference between an amount of the reward certificate and the amount of the previous reward redemptions;
create an offline reward redemption transaction record subtracting the available reward balance from a user computing device reward balance; and
write the offline reward redemption transaction record to the user computing device transaction history.

15. The system of claim 14, wherein the user computing device transaction history further comprises a listing of previous deposit transactions and a listing of previous withdrawal transactions.

16. The system of claim 15, wherein the processor is further configured to execute computer-executable instructions stored in the storage device to cause the system to:
calculate a current offline transaction amount using a transaction amount and the available reward balance;
calculate an amount of previous withdrawals using the listing of previous withdrawal transactions and an amount of previous deposits using the listing of previous deposit transactions; and
authorize, without a network connection to the computer managing the user computing device account, an offline debit transaction in response to determining that the current offline transaction amount is less than or equal to a difference between the amount of previous deposits and the amount of the previous withdrawals.

17. The system of claim 14, wherein the offline reward redemption transaction record further comprises the current offline transaction amount, and wherein the merchant mobile communication device writes the current offline transaction amount to the user computing device transaction history.

18. The system of claim 14, wherein the processor is further configured to execute computer-executable instructions stored in the storage device to cause the system to:
establish a second network connection with the computer managing the user computing device account after completing the offline redemption transaction with the user computing device, without the network connection to the computer, and
transmit the user computing device transaction history and the offline reward redemption transaction to the computer managing the user computing device account after establishing the second network connection.

19. The system of claim 18, wherein the processor is further configured to execute computer-executable instructions stored in the storage device to cause the system to receive, from the computer managing the user computing device account, a second reward certificate comprising a second reward available for redemption during an second offline payment transaction with the user computing device.

20. The system of claim 18, wherein the computer managing the user computing device account updates the user computing device account to reflect the reward redemption transaction.
